(19) United States
(12) Patent Application Publication
(10) Pub. No.: US 2019/0197352 A1
(43) Pub. Date: Jun. 27, 2019

(54) IMAGE SHARING PROMOTING APPARATUS, IMAGE SHARING PROMOTING METHOD, AND PROGRAM

(71) Applicant: FUJIFILM Corporation, Tokyo (JP)

(72) Inventor: Nao IIZAWA, Yokohama-shi (JP)

(73) Assignee: FUJIFILM Corporation, Tokyo (JP)

(21) Appl. No.: 16/201,030

(22) Filed: Nov. 27, 2018

(30) Foreign Application Priority Data
Dec. 27, 2017 (JP) 2017-251807

(51) Int. Cl. G06K 9/62; G06K 9/00; H04L 29/08; G06F 7/08; G06F 16/55

(52) U.S. Cl. CPC G06K 9/6218; G06K 9/6201; G06F 16/55; H04L 67/306; G06F 7/08; G06K 9/00362

(57) ABSTRACT

An object of the present invention is to provide an image sharing promoting apparatus, an image sharing promoting method, and a program capable of promoting sharing of images owned by a user, with dynamic preference matching of the other party of sharing for images and without requesting the other party of sharing for images to perform a special operation.

An image extracting unit extracts an image related to a trigger image from a first user terminal. A recommended information presenting unit gives a weight to the image extracted by the image extracting unit, according to a magnitude of a degree of relation, of the images and related information thereof, with the image (image α) uploaded by a user to the second SNS server, and the image (image β) uploaded by the user to the third SNS server, which are used by the user. An image, or link information on the image and accessory information on the image preferentially from the one having the largest weight given to the image extracted by the image extracting unit, are presented as recommended information.

### CROSS-REFERENCE TO RELATED APPLICATIONS

The present application claims priority under 35 U.S.C. § 119 to Japanese Patent Application No. 2017-251807, filed on Dec. 27, 2017. The above application is hereby expressly incorporated by reference, in its entirety, into the present application.

### BACKGROUND OF THE INVENTION

### 1. Field of the Invention

The present invention relates to an image sharing promoting apparatus, an image sharing promoting method, and a program, and in particular, to an image sharing promoting apparatus, an image sharing promoting method, and a program for promoting utilization of images.

### 2. Description of the Related Art

JP2017-010546A discloses that in a case where a word “travel photograph” or a sentence “transmit photographs” is entered, it is possible to search for metadata of photographs stored in a device of the other party and provide a photograph list as recommended information such that photographs imaged at the travel destination that the other party has visited together may be attached and transmitted.

JP2009-259238A discloses that subject extraction and face extraction are performed, image classification for each subject is performed, image sharing is performed, and preference matching of the other party of sharing is performed. There is disclosed that preference of images may be registered by tag information or image analysis and layout information on the preference of the other party of sharing may be also registered.

### SUMMARY OF THE INVENTION

In JP2017-010546A and JP2009-259238A, since without considering a degree of the latest interest of the other party to which images are to be transmitted, the images are transmitted, such transmission of the images is not preferable for the other party. For example, in JP2017-010546A, an image of the travel destination searched for metadata is transmitted without selection. In JP2009-259238A, since it is intended to analyze the preference of the other party of sharing in the analysis of a subject in the registered representative image and images intended to be shared, in a case where it is considered that only the subject for which interest has already been lost is shown in the representative image, only the images in which only the subject of no interest is shown are shared. In other words, as long as the representative image is not always updated, images of no interest are shared. Vice versa, in a case where it is intended to always reflect the preference of the other party of sharing, updating the representative image becomes complicated.

The present invention provides an image sharing promoting apparatus, an image sharing promoting method, and a program capable of promoting sharing of images owned by a user, with dynamic preference matching of the other party of sharing for images and without requesting the other party of sharing for images to perform a special operation.

According to a first aspect of the present invention, there is provided an image sharing promoting apparatus for promoting sharing of an image owned by a first user, from a first user terminal of the first user who is a member of a first social networking service and a second social networking service, to a second user terminal of a second user who is another member of the first social networking service and the second social networking service, the second user cooperating with the first user on the first social networking service and the second social networking service, the apparatus comprising: an information acquiring unit that acquires information to be transmitted and received between the first user terminal and the second user terminal; an image extracting unit that extracts one or more images related to the acquired information from an image group owned by the first user; and a presenting unit that performs a presentation for promoting sharing of the extracted one or more images with the second user, at the first user terminal, in which the image extracting unit gives a weight to each of one or more images related to the acquired information, based on the number of members with which the second user cooperates in each of the first social networking service and the second social networking service, and extracts one or more images to be shared with the second user, from the image group owned by the first user, based on the weight given to each of one or more images related to the acquired information.

According to this aspect, a weight is given to each of one or more images related to the acquired information, based on the number of members with which the second user cooperates in each of the first social networking service and the second social networking service, and one or more images to be shared with the second user are extracted from the image group owned by the first user, based on the weight given to each of one or more images related to the acquired information. That is, it is possible to extract the shared image dynamically reflecting a tendency of the preference of the second user and a strength of interest thereof based on the number of members, without requesting the first user or the second user to perform a special operation.

In the image sharing promoting apparatus according to a second aspect of the present invention, the information acquired by the information acquiring unit includes an image, and the image extracting unit extracts one or more images related to the acquired information based on at least one of imaging date and time, sharing date and time, a degree of image similarity, or keyword and tag information of the image, from the image group owned by the first user.

According to a third aspect of the present invention, there is provided the image sharing promoting apparatus further comprising: a sorting unit that sorts the image group owned by the first user into a plurality of folders corresponding to a plurality of groups of the first social networking service and the second social networking service to which the first user belongs, in which the information acquired by the information acquiring unit includes an image, and the sorting unit extracts one or more images to be sorted, out of the image group, based on the acquired imaging date and time of the image, analyzes the extracted image to identify one or more persons included in the image, and sorts the extracted image into the plurality of folders according to the identified person, and the image extracting unit extracts one or more images from a folder into which images, in which a person related to an image acquired by the information acquiring unit is identified, are sorted.

In the image sharing promoting apparatus according to a fourth aspect of the present invention, the image extracting unit gives a weight to each of images including the same person as a person included in an image uploaded from the second user terminal to the first social networking service and the second social networking service, based on the number of members with which the second user cooperates in each of the first social networking service and the second social networking service, and extracts one or more images to be shared with the second user, from the image group owned by the first user, based on the weight given to each of one or more images related to the acquired information.

In the image sharing promoting apparatus according to a fifth aspect of the present invention, the image extracting unit gives a weight to each of images accompanied with the same keyword as a keyword included in a comment accompanying an image uploaded from the second user terminal to the first social networking service and the second social networking service, based on the number of members with which the second user cooperates in each of the first social networking service and the second social networking service, and extracts one or more images to be shared with the second user, from the image group owned by the first user, based on the weight given to each of one or more images related to the acquired information.

In the image sharing promoting apparatus according to a sixth aspect of the present invention, the image extracting unit gives a weight to each of images having a feature amount similar to a feature amount of an image uploaded from the second user terminal to the first social networking service and the second social networking service, based on the number of members with which the second user cooperates in each of the first social networking service and the second social networking service, and extracts one or more images to be shared with the second user, from the image group owned by the first user, based on the weight given to each of one or more images related to the acquired information.

In the image sharing promoting apparatus according to a seventh aspect of the present invention, the image extracting unit gives a weight to each of images having imaging position information that is the same as or close to the imaging position information of an image uploaded from the second user terminal to the first social networking service and the second social networking service, based on the number of members with which the second user cooperates in each of the first social networking service and the second social networking service, and extracts one or more images to be shared with the second user, from the image group owned by the first user, based on the weight given to each of one or more images related to the acquired information.

In the image sharing promoting apparatus according to an eighth aspect of the present invention, the first social networking service is a limited-public type and the second social networking service is a fully-public type.

According to a ninth aspect of the present invention, there is provided an image sharing promoting method for promoting sharing of an image owned by a first user, from a first user terminal of the first user who is a member of a first social networking service and a second social networking service, to a second user terminal of a second user who is another member of the first social networking service and the second social networking service, the second user cooperating with the first user on the first social networking service and the second social networking service, the method comprising: a step of acquiring information to be transmitted and received between the first user terminal and the second user terminal; a step of extracting one or more images related to the acquired information from the image group owned by the first user; a step of giving a weight to each of one or more images related to the acquired information, based on the number of members with which the second user cooperates in each of the first social networking service and the second social networking service, and extracting one or more images to be shared with the second user, from the image group owned by the first user, based on the weight given to each of one or more images related to the acquired information; and a step of performing a presentation for promoting sharing of the extracted one or more images with the second user, at the first user terminal.

An image sharing promoting program according to a tenth aspect of the present invention, causes a computer to execute the image sharing promoting method.

According to the present invention, the second user gives a weight based on the number of members cooperating in each of the first social networking service and the second social networking service, and one or more images to be shared with the second user are extracted from the image group owned by the first user based on the weight given to each of one or more images related to the acquired information. That is, it is possible to extract the shared image dynamically reflecting a tendency of the preference of the second user and a strength of interest thereof based on the number of members, without requesting the first user or the second user to perform a special operation.

### BRIEF DESCRIPTION OF THE DRAWINGS

FIG. 1 is a schematic configuration diagram of an image sharing promoting system.

FIG. 2 is a diagram showing a relationship between a user A and a user B on an SNS.

FIG. 3 is a block diagram of an image sharing promoting apparatus.

FIG. 4 is a diagram showing an example of the sorting of images.

FIG. 5 is a flowchart of image sharing promotion processing.

### DESCRIPTION OF THE PREFERRED EMBODIMENTS

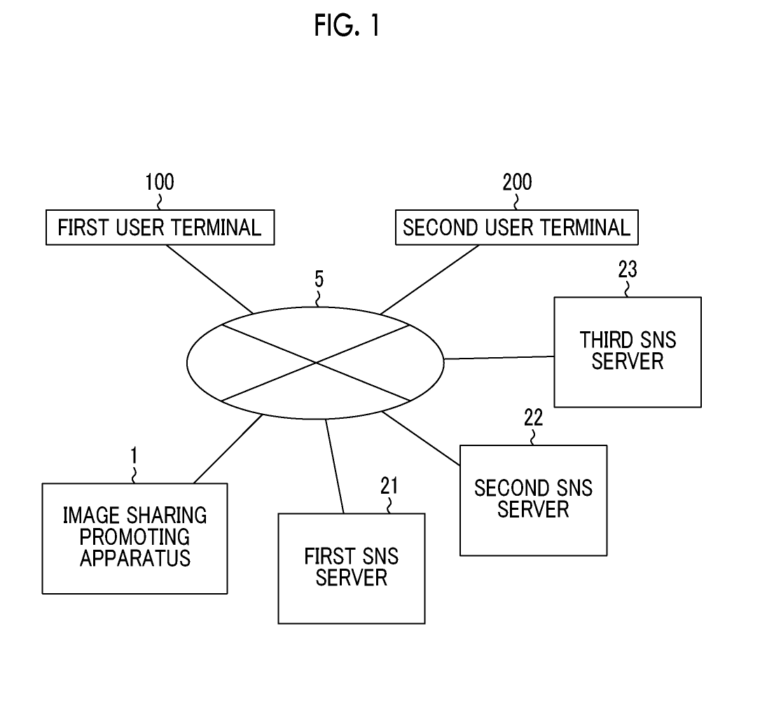

FIG. 1 is a schematic configuration diagram of an image sharing promoting system according to a first preferred embodiment of the present invention. The image sharing promoting system comprises an image sharing promoting apparatus 1, a first user terminal 100, a second user terminal 200, a first Social Networking Service (SNS) server 21, a second Social Networking Service (SNS) server 22, and a third Social Networking Service (SNS) server 23 in connection with one another through a network 5 such as the Internet. All the image sharing promoting apparatus 1, the first user terminal 100, the second user terminal 200, the first SNS server 21, the second SNS server 22, and the third SNS server 23 may be configured with a known computer. The image sharing promoting apparatus 1 may be incorporated into any one of the first user terminal 100, the second user terminal 200, the first SNS server 21, the second SNS server 22, or the third SNS server 23.

The first SNS server 21 is a known server that manages to share information among a plurality of users including a user (user A) of the first user terminal 100) and a user (user B) of the second user terminal 200. The information managed by the first SNS server 21 is a rule of sharing various types of information such as a message, an image, and position information, according to a relationship (friends, members of a community, and the like) on information linkage between users, sharing according to a rule of information uploaded from each user, and the like.

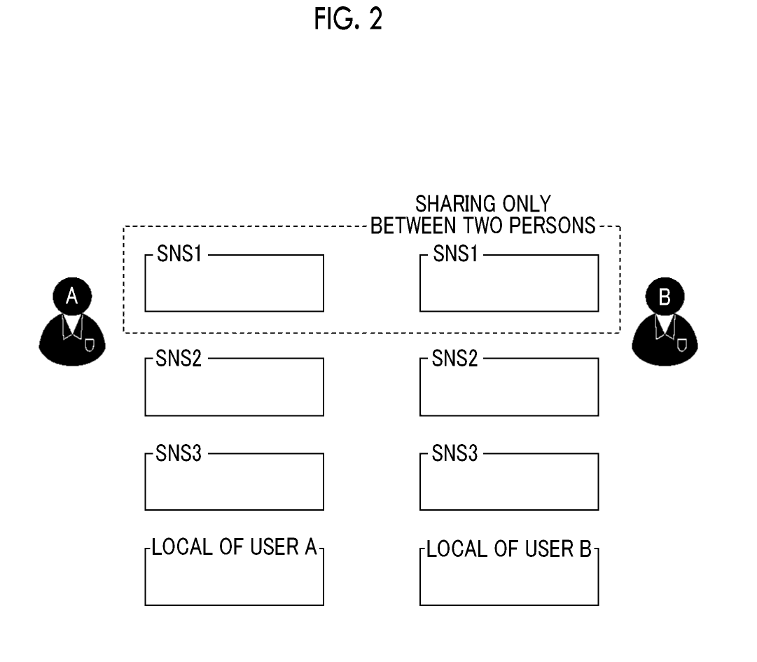

Herein, as shown in FIG. 2, it is considered that the relationship between the user A of the first user terminal 100 and the user B of the second user terminal 200 through the first SNS server 21 is a relationship of friends on a non-public type SNS1 (“LINE(registered trademark)”). The non-public type means that communication contents are disclosed only between specified users.

The relationship between the user A of the first user terminal 100 and the user B of the second user terminal 200 through the second SNS server 22 is a relationship of friends on a limited-public type SNS2 (“Facebook (registered trademark)”). The limited-public type means that the communication contents other than communication contents between specified users are non-public to unspecified users and only designated information is disclosed to unspecified users.

The relationship between the user A of the first user terminal 100 and the user B of the second user terminal 200 through the third SNS server 23 is a relationship for which the user A is a follower on a fully-public type SNS3 of the user B (“Twitter (registered trademark)”, or “Instagram (registered trademark)”). The fully-public type means that communication contents are fully disclosed between unspecified users. However, it is also possible to individually designate a specified other party and to individually refuse to disclose information (block). Both the limited-public type and the fully-public type have a common point that it is possible to share information in an unspecified manner. The limited-public type and the fully-public type are collectively referred to as a public type.

Examples of the non-public type SNS, the limited-public type SNS, or a fully-public type SNS are as follows.

Non-public type . . . LINE, WhatApp. Wechat, and Cacao Talk
Limited-public type . . . Facebook, Weibo, LinkedIn, and Google+
Fully-public type . . . Twitter, and Instagram

The first user terminal 100 and the second user terminal 200 may access the first SNS server 21 and the like through the network 5 and may share various types of information such as images and texts to each other. A plurality of the second user terminals 200 may be provided.

The user A who is a local user uses the first user terminal 100 to own an image. The user B who is another local user uses the second user terminal 200 to own another image.

Here, that the user A or the user B “owns” an image includes that the user A or the user B stores an image optionally designated by themselves to be controllable in the first user terminal 100, the second user terminal 200, various types of SNS servers such as the first SNS server 21, other computers (not shown), cloud computing, or a computer-readable storage medium. The fact that the user A or the user B is able to control an image means that the user A or the user B has authority for using the image in terms of software such as reading out, browsing, transmitting, copying, editing, printing or setting of access authority.

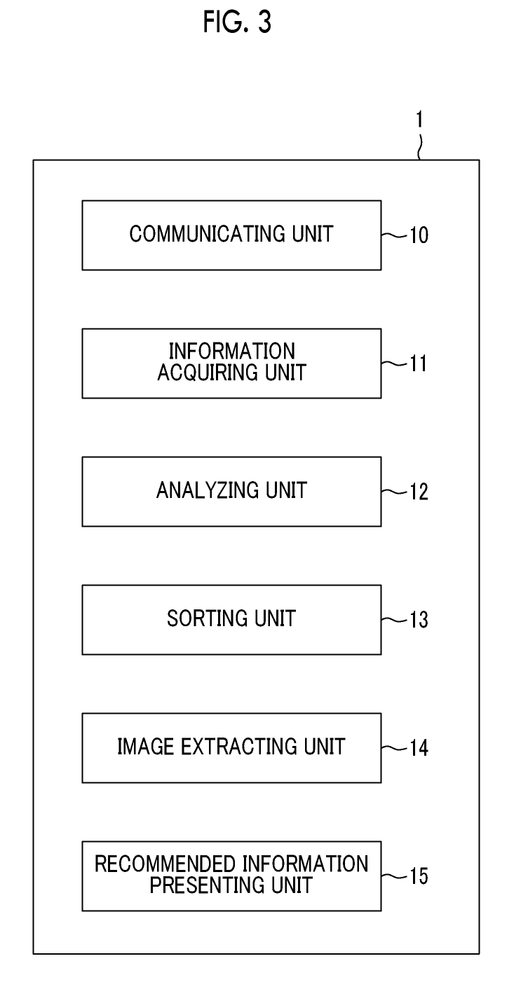

FIG. 3 is a configuration diagram of the image sharing promoting apparatus 1. The image sharing promoting apparatus 1 comprises a communicating unit 10, an information acquiring unit 11, an analyzing unit 12, a sorting unit 13, an image extracting unit 14, and a recommended information presenting unit 15. The communicating unit 10, the information acquiring unit 11, the analyzing unit 12, the sorting unit 13, the image extracting unit 14, and the recommended information presenting unit 15 of the image sharing promoting apparatus 1 are configured with various types of processors (information processing apparatuses) such as one or a plurality of CPUs and peripheral circuits (RAM, ROM, and the like) thereof.

The communicating unit 10 is connected to the first user terminal 100, the second user terminal 200, the first SNS server 21, the second SNS server 22, and the third SNS server 23 through the network 5, and transmits and receives various types of information.

The information acquiring unit 11 acquires an image (trigger image) uploaded from the first user terminal 100 to the first SNS server 21 and attachment information on the trigger image (such as a comment attached to the image uploaded to the first SNS server 21).

The analyzing unit 12 analyzes a trigger image (also attachment information in a case where attachment information is provided) acquired through the information acquiring unit 11, and acquires information related to the trigger image such as a feature amount of the image (histogram, frequency, and the like), metadata (aperture, shutter speed, imaging position information configured with a Global Positioning System (GPS), and the like), annotation information, subject information, and a keyword in the comment.

According to the imaging position, the imaging date and time, and a sorting rule related to a subject, for each predetermined group, the sorting unit 13 sorts, for each of the identified imaging date and time and the subject, images other than the trigger image stored in the first user terminal 100.

For example, it is considered that a trigger image I, an image I1, an image I2, an image I3, an image I4, and . . . are stored in the first user terminal 100, and the image I is uploaded to the first SNS server 21. It is considered that all the imaging date and time T of the image I1, the image I2, and the image I3 are the same as the imaging date and time of the trigger image I, the users A and B are shown in the image I1, the user B is shown in the image I2, a certain subject X is shown in the image I3, and another subject Y is shown in the image I4.

It is considered that, as a sorting rule, regardless of the imaging position and imaging date and time, in a case where a subject included in an image is the user B, a sorting rule R1 that sorts the image into a group of “images shared with the user B” comes into effect; regardless of the imaging position and imaging date and time, in a case where the subject included in an image is the user X, a sorting rule R2 that sorts the image into a group of “images shared by a group 1” comes into effect; regardless of the imaging position and imaging date and time, in a case where the subject included in an image is the user Y, a sorting rule R3 that sorts the image into a group of “images shared by a group 2” comes into effect; in a case of an image having some imaging date and time between the imaging date and time of the two images sorted into the group of “images shared with the user B” and including neither the user A nor the user B as a subject, a sorting rule R4 that sorts the image into the group of “images shared with the user B” comes into effect.

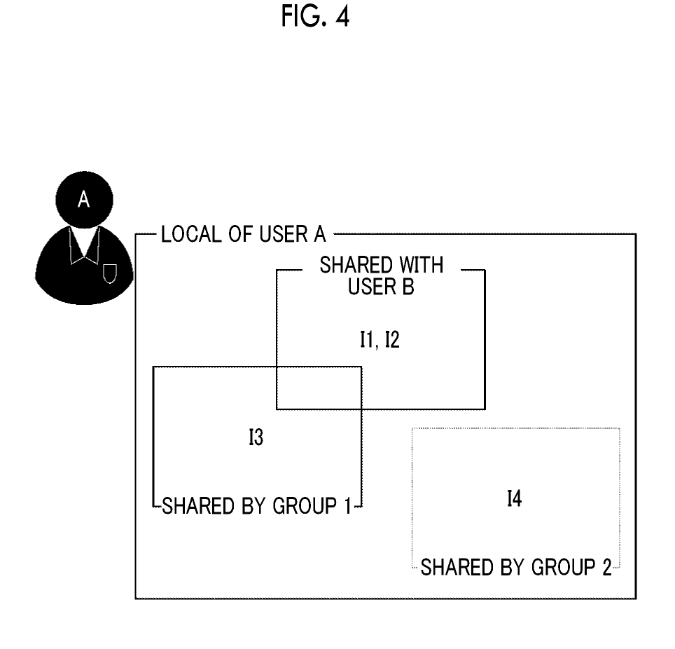

In this case, as shown in FIG. 4, the images I1 and I2 are sorted into the group of “images shared with the user B”, the image I3 is sorted into the group of “images shared by the group 1”, and the image I4 is sorted into the group of “images shared by the group 2”, respectively.

The imaging date and time intended for a reference of sorting may be a specified time point or a time band (forenoon, afternoon, and the like) of a certain specified date.

The sorting rule is not limited to the aforementioned. For example, an image including both the user A and the user B as the subject may be sorted into the group of “images shared with the user B”. By machine learning a tendency of information related to an image such as the subject, the imaging date and time, the imaging position, and the image feature amount of an image uploaded to the first SNS server 21 to the third SNS server 23 and actually shared between the user A and the user B, and the comment attached to the image, a sorting rule that sorts the image into the group of “images shared with user B” may be constructed. For example, from the contents of the comment on the image shared between the user A and the user B uploaded to the first SNS server 21, date and time other than the date and time when the user A and the user B met is estimated, and all the images of the other imaging date and time are sorted into the group of “images shared with the user B”.

Based on the analysis result of the information related to the trigger image, the image extracting unit 14 extracts an image related to the trigger image from the first user terminal 100. For example, the image extracting unit 14 extracts an image other than the trigger image, having the same imaging date and time, and the same subject as those of the trigger image, an image accompanied by a keyword or tag information same as or similar to the keyword or tag information accompanying the trigger image, and an image having an image feature amount similar to the image feature amount of the trigger image, and the like, from the first user terminal 100.

For example, in a case where the subject B is shown in the trigger image, the image extracting unit 14 extracts the image I1 and the image I2 that have been sorted into a folder of “images in which the subject B is shown”.

The recommended information presenting unit 15 presents the image extracted by the image extracting unit 14 to the first user terminal 100 as an image to recommend sharing from the user A to the user B. Instead of presenting the image as it is, a link for jumping to a stored destination of the image may be presented. Various types of accessory information such as a keyword, a comment, and a tag, accompanying the image may be presented along with the image or the link.

In the example of FIG. 4 described above, the images I1 and 12 that have been sorted into the folder of “images in which the subject B is shown” may be presented as the image to recommend sharing as it is, but since actually the image I1 and the image I2 do not have exactly the same contents, it is desired to preferentially recommend sharing of an image in which the user B is more interested.

Therefore, the image extracting unit 14 gives a weight to each of the images of the folder, according to a magnitude of a degree of relation, of the images (the image I1 and the image I2) sorted into the folder of “images in which the subject B is shown” and the related information thereof, with an image (image α) uploaded by the user B to the second SNS server 22 and the third SNS server 23 and another image (image β) uploaded by the user B to the third SNS server, which are used by the user B.

For example, weights according to the degree of relation are as follows.

(1) In the case where the image I1 has the same subject as the subject of the image α and the image I2 has the same subject as the subject of the image β, a weight to an image I2 having the subject and uploaded to the third SNS server that has higher publicity than the publicity of the second SNS server 22 is made larger than a weight of the image I1.

(2) In a case where the comment attached to the image I1 has the same keyword as the keyword of the comment attached to the image α (a name of a specified celebrity, and the like) and the comment attached to the image I2 has the same keyword as the keyword of the comment attached to the image β, a weight of the image I2 having the subject and uploaded to the third SNS server that has higher publicity than the publicity of the second SNS server 22 is made larger than a weight of the image I1.

(3) In a case where the image feature amount of the image I1 is similar to the image feature amount of the image α and the image feature amount of the image I2 is similar to the image feature amount of the image β, a weight to an image I2 having the subject and uploaded to the third SNS server that has higher publicity than the publicity of the second SNS server 22 is made larger than a weight of the image I1.

(4) In a case where the image I1 has the imaging position information that is the same as or is close to the imaging position information of the image α in a certain range, and the image I2 has the imaging position information that is the same as or close to the imaging position information of the image β in a certain range, a weight to an image I2 having the subject and uploaded to the third SNS server that has higher publicity than the publicity of the second SNS server 22 is made larger than a weight of the image I1.

(5) In a case where the weight of the image I1 is neither superior nor inferior to the weight of the image I2 in (1) to (4), a weight of one of image I1 and image I2 corresponding to the larger reaction out of a reader's reaction (retweet or “like”) to the image α having relation with any one of the image I1 and the image I2 and a reader's reaction to the image β in (1) to (4), is made larger than a weight of the other one of the image I1 and the image I2 corresponding to the smaller reaction out of the reader's reactions.

The recommended information presenting unit 15 presents recommended information preferentially from the one with the largest weight. These weights are summed up and recommended information is presented preferentially from the one with the largest weight. A method of presenting the preferential recommended information is optional, and may include, for example, presenting top N number of images (N is an integer of 1 or more) or the like, and presenting an image or the like in order from the one with the largest weight to the one with the smallest weight.

Although weights may be determined mechanically according to a magnitude of the publicity of an SNS, weights may be determined according to a quantity of the number of active users of the SNS, who have accessed articles (comments, images, and the like) uploaded by the user B to the SNS. For example, in a case where the number of active users of the second SNS server 22 is more than the number of active users of the third SNS server 23, a weight of the image published by the second SNS server 22 is made larger. Vice versa, in a case where the number of active users of the second SNS server 22 is less than the number of active users of the third SNS server 23, a weight of the image published by the second SNS server 22 is made smaller. In this way, it is possible to present a recommended image from the images owned by the user A according to a degree of attention to the user B's articles.

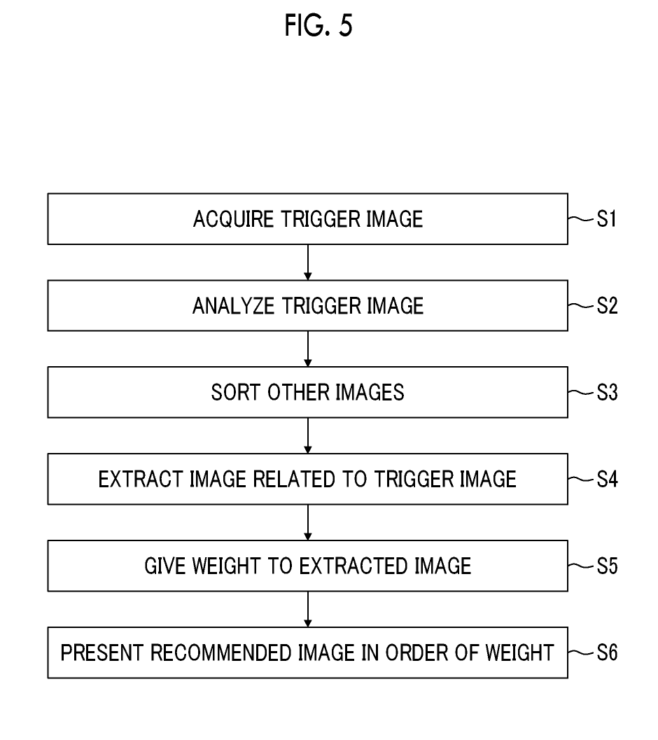

FIG. 5 is a flowchart showing the flow of the image sharing promotion processing executed by the image sharing promoting apparatus 1. The image sharing promoting program for causing the image sharing promoting apparatus 1 to execute this information presentation processing is stored in a non-transitory tangible medium (ROM or the like) that is readable by the image sharing promoting apparatus 1.

In S1 (trigger image acquiring step), the information acquiring unit 11 acquires a trigger image through the communicating unit 10.

In S2 (trigger image analyzing step), the analyzing unit 12 analyzes the trigger image, analyzes the trigger image identification, and acquires information related to the trigger image, such as the feature amount of the image, the metadata, the annotation information, the subject information, the keyword in the comment, and the sharing date and time of the image.

In S3 (image sorting step), the sorting unit 13 sorts images other than the trigger image stored in the first user terminal 100 into a folder, according to a sorting rule based on information related to the image, such as an imaging position, imaging date and time, and a subject, for each predetermined group.

In S4 (image extracting step), the image extracting unit 14 extracts an image from the folder related to the trigger image.

In S5 (weighting step), the image extracting unit 14 gives a weight to an image, according to a magnitude of a degree of relation, of the image sorted into the folder related to the trigger image and related information thereof, with an image (image α) uploaded by the user B to the second SNS server 22 and another image (image β) uploaded by the user B to the third SNS server, which are used by the user B.

In S6 (recommended information presenting step), the recommended information presenting unit 15 extracts the image (or link information on the image and accessory information on the image) preferentially from the one having the largest weight attached to the image extracted by the image extracting unit 14, as recommended information.

As described above, according to the degree of publicity on the SNS of the image uploaded by the user B to the SNS, a weight is given to the image of the user A related to the trigger image, and according to the weight, a recommended image to be shared by the user B is presented to the user A. Therefore, it is possible to dynamically present a recommended image according to the interest of the user B without requesting the user A or the user B to perform a special operation.

Out of the image α and the image β related to the trigger image, as the recommended image from the user B, a certain number of images satisfying certain conditions, such as images having a large size of the subject or having good image quality, may be presented to the second user terminal 200 and may be promoted to be shared with the user A through the first SNS server 21.

The extracted source of the image related to the recommended image may be a user terminal of another user C, which is neither the first user terminal 100 nor the second user terminal 200. For example, the recommended image may be extracted from public images uploaded from the user terminal of the user C to the second SNS server 22 or the third SNS server 23.

Furthermore, the image sharing promoting apparatus 1 according to an embodiment of the present invention may be any type of a terminal device as long as it is a terminal device owned or managed by the user A. For example, the image sharing promoting apparatus 1 may be one in which software configured with a program according to an embodiment of the present invention is installed on a personal computer owned or managed by the user A. Alternatively, the image sharing promoting apparatus 1 may be one in which an application configured with the program according to an embodiment of the present invention is installed on a smart device such as a smartphone or tablet owned or managed by the user A. The terminal device owned or managed by the user A and another server may cooperate to configure the image sharing promoting apparatus 1 according to the embodiment of the present invention.

### EXPLANATION OF REFERENCES

1: image sharing promoting apparatus
5: network
10: communicating unit
11: information acquiring unit
12: analyzing unit
13: sorting unit
14: image extracting unit
15: recommended information presenting unit
21: first SNS server
22: second SNS server
23: third SNS server
S1: trigger image acquiring step
S2: trigger image analyzing step
S3: image sorting step
S4: image extracting step
S5: weighting step
S6: recommended information presenting step

What is claimed is:

1. An image sharing promoting apparatus for promoting sharing of an image owned by a first user, from a first user terminal of the first user who is a member of a first social networking service and a second social networking service, to a second user terminal of a second user who is another member of the first social networking service and the second social networking service, the second user cooperating with the first user on the first social networking service and the second social networking service, the apparatus comprising:
an information acquiring unit that acquires information to be transmitted and received between the first user terminal and the second user terminal;
an image extracting unit that extracts one or more images related to the acquired information from an image group owned by the first user; and
a presenting unit that performs a presentation for promoting sharing of the extracted one or more images with the second user, at the first user terminal,
wherein the image extracting unit gives a weight to each of one or more images related to the acquired information, based on the number of members with which the second user cooperates in each of the first social networking service and the second social networking service, and extracts one or more images to be shared with the second user, from the image group owned by the first user, based on the weight given to each of one or more images related to the acquired information.

2. The image sharing promoting apparatus according to claim 1,
wherein the information acquired by the information acquiring unit includes an image, and
the image extracting unit extracts one or more images related to the acquired information based on at least one of imaging date and time, sharing date and time, a degree of image similarity, or keyword and tag information of the image, from the image group owned by the first user.

3. The image sharing promoting apparatus according to claim 1, further comprising:
a sorting unit that sorts the image group owned by the first user into a plurality of folders corresponding to a plurality of groups of the first social networking service and the second social networking service to which the first user belongs,
wherein the information acquired by the information acquiring unit includes an image, and
the sorting unit
extracts one or more images to be sorted, out of the image group, based on the acquired imaging date and time of the image,
analyzes the extracted image to identify one or more persons included in the image, and
sorts the extracted image into the plurality of folders according to the identified person, and
the image extracting unit extracts one or more images from a folder into which images, in which a person related to an image acquired by the information acquiring unit is identified, are sorted.

4. The image sharing promoting apparatus according to claim 1,
wherein the image extracting unit gives a weight to each of images including the same person as a person included in an image uploaded from the second user terminal to the first social networking service and the second social networking service, based on the number of members with which the second user cooperates in each of the first social networking service and the second social networking service, and extracts one or more images to be shared with the second user, from the image group owned by the first user, based on the weight given to each of one or more images related to the acquired information.

5. The image sharing promoting apparatus according to claim 1,
wherein the image extracting unit gives a weight to each of images accompanied with the same keyword as a keyword included in a comment accompanying an image uploaded from the second user terminal to the first social networking service and the second social networking service, based on the number of members with which the second user cooperates in each of the first social networking service and the second social networking service, and extracts one or more images to be shared with the second user, from the image group owned by the first user, based on the weight given to each of one or more images related to the acquired information.

6. The image sharing promoting apparatus according to claim 1,
wherein the image extracting unit gives a weight to each of images having a feature amount similar to a feature amount of an image uploaded from the second user terminal to the first social networking service and the second social networking service, based on the number of members with which the second user cooperates in each of the first social networking service and the second social networking service, and extracts one or more images to be shared with the second user, from the image group owned by the first user, based on the weight given to each of one or more images related to the acquired information.

7. The image sharing promoting apparatus according to claim 1,
wherein the image extracting unit gives a weight to each of images having imaging position information that is the same as or close to the imaging position information of an image uploaded from the second user terminal to the first social networking service and the second social networking service, based on the number of members with which the second user cooperates in each of the first social networking service and the second social networking service, and extracts one or more images to be shared with the second user, from the image group owned by the first user, based on the weight given to each of one or more images related to the acquired information.

8. The image sharing promoting apparatus according to claim 1,
wherein the first social networking service is a limited-public type and the second social networking service is a fully-public type.

9. An image sharing promoting method for promoting sharing of an image owned by a first user, from a first user terminal of the first user who is a member of a first social networking service and a second social networking service, to a second user terminal of a second user who is another member of the first social networking service and the second social networking service, the second user cooperating with the first user on the first social networking service and the second social networking service, the method comprising:
a step of acquiring information to be transmitted and received between the first user terminal and the second user terminal;
a step of extracting one or more images related to the acquired information from the image group owned by the first user;
a step of giving a weight to each of one or more images related to the acquired information, based on the number of members with which the second user cooperates in each of the first social networking service and the second social networking service, and extracting one or more images to be shared with the second user, from the image group owned by the first user, based on the weight given to each of one or more images related to the acquired information; and
a step of performing a presentation for promoting sharing of the extracted one or more images with the second user, at the first user terminal.

10. A non-transitory computer-readable tangible medium which stores an image sharing promoting program for causing a computer to execute the image sharing promoting method according to claim 9.
